(19) United States
(12) Patent Application Publication
(10) Pub. No.: US 2007/0258048 A1
(43) Pub. Date: Nov. 8, 2007

(54) Monitoring Expiration Dates of Perishable Products

(75) Inventor: Stephen Michael Pitchers, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,359

(22) PCT Filed: Aug. 9, 2005
(86) PCT No.: PCT/IB05/52638

§ 371 Date: Feb. 7, 2007

(30) Foreign Application Priority Data
Aug. 11, 2004 (EP) 04103866.2

(51) Int. Cl. G06K 17/00

(52) U.S. Cl. 353/26 R; 340/572.1

(57) ABSTRACT

An RFID tag (210) for provision on the package (240) of a perishable product, such as a foodstuff, the expiration of the product being influenced by opening of the package (240). The tag (210) is arranged to determine when the package (240) has been opened and, in response to opening of the package (240), a timer (214) is triggered to measure time elapsed following opening of the package (240), such that data representative of an expiration status of the product can be provided. Temperature sensing means (215) may also be provided to monitor the storage condition of the product after opening of the package (240), and to adjust the expiration status accordingly.

### FIELD OF THE INVENTION

This invention relates to a method for determining an expiration date of a perishable product such as foodstuffs, pharmaceuticals and other medical supplies contained within a package, wherein expiration of said product is influenced by the opening of said package. The invention furthermore relates to a tag, a package such as tins, jars, pouches, boxes, etc. and a reader to provide the inventive method.

### BACKGROUND OF THE INVENTION

The calculation and subsequent monitoring of expiration or “use by” dates of perishable goods is not trivial, and, in many cases, involves significantly more consideration than simply looking at the “use by” or “best before” dates on the product packaging. For instance, the safe or useful life of a perishable product is often dependent on the temperature at which it is stored. Take as an example a loaf of bread, which may become stale after three days if stored at room temperature, whereas it may remain fresh for five days or more if kept refrigerated. If the loaf is to be frozen, it should ideally be frozen on the day of purchase, in which case it should last for a month at standard freezer temperature. Once defrosted, however, it should be consumed within 24 hours.

U.S. Pat. No. 6,712,276 describes a system and method for determining dynamic properties of perishable and/or consumable products, which include foodstuffs, medical supplies (e.g. pharmaceuticals) and biological specimens. An electronic tag is attached to a product, wherein one or more sensor sub-units are integrated into the tag for determining respectively one or more dynamic properties of the product and reporting the results of such determination (periodically) to a remote device via radio frequency transmission. One such sensor sub-unit may comprise a temperature sensing device for effecting temperature measurements in respect of the perishable product and then transmitting the results of such measurements to remote device for processing thereby to determine the expiration date of the product.

The US 2004/0008123 furthermore discloses a system for monitoring medical devices, such as pharmaceuticals and prescriptions by use of Radio Frequency Identification (RFID) techniques. The system includes an RFID tag associated with the medical device, the tag programmed with information about the device. In one embodiment the tag is configured to provide status information about a container for pharmaceuticals such as the opening status of the container.

The U.S. Pat. No. 6,294,997 finally discloses an RFID tag with a timing module to measure elapsed time and an environment module to detect certain environmental condition such as temperature or pressure. The environment module enables a user to determine how long the RFID tag has been exposed to certain environmental conditions that have been pre-defined by the user.

However, the determination of expiration dates is, in many cases, more complex than simply determining the temperature at which the perishable product has been stored over a period of time. Consider, for example, the case of products packaged in jars, tins and vacuum packs. Such packages are filled in a protective atmosphere that excludes spoiling agents from the inside of the packaging, thereby extending the shelf life of the product considerably. However, once the packaging is opened and ambient air enters the packaging, the contents are then required to be consumed or discarded within a predetermined time, say three days, and this predetermined time may also depend on the temperature at which the product is stored after the packaging has been opened. Upon discovering a perishable product in respect of which the package has been opened, unless the user can remember precisely when the package was opened, it is very difficult to determine the expiration date of the product. The “use by” or “best before” date printed on the packaging is of little assistance in these circumstances, as this date will reflect the maximum shelf life of the product when the packaging remains unopened.

### OBJECT AND SUMMARY OF THE INVENTION

Thus, it is an object of the present invention to provide a system and method for monitoring at least one storage parameter of a perishable item, after the packaging thereof has been opened, so as to enable determination of an expiration date of the perishable item.

In accordance with the present invention, there is provided a method of monitoring an expiration status of a perishable product contained within a package, wherein expiration of said product is influenced by the opening of said package, the method comprising the steps: detecting the opening of said package, determining an expiration date of said product for the open package caused by said detecting the opening of said package, and supplying data representative of the expiration date.

Also in accordance with the present invention, there is provided an electronic tag for provision in or on a package containing a perishable product, wherein expiration of said product is influenced by the opening of said package, said tag comprising: means for detecting the opening of said package, means for determining an expiration date of said product for the open package, and means for supplying data representative of an expiration date of said product. Preferable said features and further following features are integrated or at least combined with a well known Radio Frequency Identification Tag, short RFID tag. Relevant information is published in the standards ISO 10536, ISO 14443 and ISO 15693 for example.

Still further in accordance with the present invention, there is provided a package for monitoring an expiration status of a perishable product contained within said package, wherein expiration of said product is influenced by the opening of said package, the package comprising: means in or on said package for detecting the opening of said package, means for determining an expiration date of said product for the open package, and means for supplying data representative of an expiration date of said product.

The present invention also extends to a reading device comprising: means for receiving from a remote location a signal indicating that a package containing a perishable product has been opened, wherein expiration of said product is influenced by the opening of said package, and means for determining an expiration date of said product for the open package.

Thus, the present invention enables an expiration date of a perishable product, which expiration date is influenced by the opening of the package containing the product, to be determined in direct response to the opening of the package. Many products spoil relatively slowly when the package is closed but comparatively quickly when the package has been opened. An example would be sardines in a tin. In this case it is important to detect the opening of the package and to determine an expiration date. An easy embodiment would be a timer which is loaded with an initial value, for example 24 hours and started when the package is opened, counting backward. Of course it is also possible that a timer is started at zero and counts upwards to a certain value. Determination of an expiration date can also be performed by simply adding a certain value to the actual date and store the result as an new expiration date. An interrogating reading device can then directly read out the expiration date without any necessary computing steps. The expiration date can further be determined by adjusting the value of a running timer. It is possible that a timer is counting backwards the days until a product is spoiled from the day when the product is manufactured. So a timer can be loaded for example with an initial value of 30 days until the product is spoiled when the package is closed. But when the package is opened the product spoils faster. So the actual value of the timer (e.g. there are 7 days left) is overwritten with a new value, for example 1 day so that the timer reaches zero (when counting downwards) or a certain value (when counting upwards) at the moment when the product is spoiled. Data representative of an expiration date of said product can then be transmitted to a reading device. Besides a certain expiration day or a time span until that day, data can also comprise a certain status of a product such as “excellent”, “good”, or “spoiled”.

It is preferred if at least one parameter affecting expiration of said product is monitored and the expiration date is adjusted according to monitored parameter(s). Taking a predetermined time span for determining an expiration date is a more or less rough method that works well for a certain kind of products but is preferably refined when it is applied to another group of products that are relatively sensitive to storage conditions. Whereas sardines should be consumed in any case within, lets say, one day irrespective of storage conditions, a jar of pasta can even be consumed comparatively late after opening provided it is cooled. So an important parameter affecting the expiration of a product is temperature, which can be measured on a regular basis. If temperature is kept within a predefined range, for example below 8 degrees Celsius, the estimated expiration date for the open package is not adjusted. If the temperature moves above this value the expiration date is adjusted, in this case shortened. It is also possible that an expiration date is estimated for bad conditions and extended when the storage conditions are better than expected. This might be accomplished with the aid of tables that contain information how fast a product spoils under a certain condition. This information can be the result of an experiment carried out for a certain product.

It is further preferred that parameter monitoring and expiration date adjusting is commenced by said detecting the opening of said package. This has the added advantage of minimising power consumption, because the monitor means is only active when required. Furthermore a memory which is arranged to store a history of storage condition is also smaller than a memory for a method where measurements are taken all the time. For example a processor of the tag can monitor an opening detector and activate parameter monitoring when it detects a status change of the opening detector.

It is also preferred that said means for detecting the opening of package comprise means for receiving a signal from a remote detection means indicating that the package has been opened. In this way tag and opening detector are separate parts so that the opening detector and tag can be mounted at a different locations. For example the opening detector is mounted on the lid of a jar. Because the lid is made of metal it could influence the radio communication between tag and reader. Hence the tag is mounted at the bottom of the jar and connected to the remote opening detector.

Advantageously detecting the opening of said package comprises one or more of monitoring a pressure within the package, monitoring the status of a rip strip, or a mechanical switch. If the product is filled under vacuum for example the pressure within a package significantly changes when it is opened. Thus a measurement of pressure can be used for opening detection. This also works for leaky packages where the pressure changes slowly, which is interpreted as a “slow” opening. Anyway incoming oxygen accelerates the spoiling of the product. Besides a pressure sensor simple mechanical constructions like mechanical switches in a pop-up button of a lid as well as rip strips can be used for opening detection. A rip strip for example is particularly applicable for cardboard or plastic packages with a jagged strip for opening as known from breakfast cereals, etc. Simply arranging the conductive rip strip across the jagged strip would lead to a break of the rip strip upon tearing the jagged strip off.

It is further advantageous when detecting the opening of said package and monitoring at least one parameter affecting expiration of said product is achieved by one single pressure sensor. Hence a pressure sensor serves in a synergetic way since an expiration date can also depend on pressure within a package after the package was opened. An example would be a product that ferments when it gets in contact with oxygen, which normally increases the pressure within a package. If this pressure is measured the expiration date can be calculated more precisely.

In a preferred embodiment, the parameter affecting the expiration of the product after the package has been opened comprises time, wherein a product is determined to expire a predetermined time after the package is opened. Beneficially, temperature of the product and/or its surroundings may be monitored after the package has been opened. It is also preferred to measure the pressure within the package. A further possibility is to measure the atmosphere within a package because oxygen usually accelerates the spoiling of products.

The method may further comprise the triggering of an external warning signal indicating that the product has expired or is about to expire. In the first case a user gets the information that a product is already spoiled, in the second case he additionally gets the opportunity to consume the product before it is spoiled. The warning signal can also comprise a product status such as “nearly spoiled” or “spoiled”.

The aforesaid facts are applicable to the inventive method, the inventive tag, the inventive package as well as to an inventive reader. Some of the functions can further be integrated into a reader, which will result in a function split. So it is possible that a reading device comprises means for receiving from a remote location a signal indicating that a package containing a perishable product has been opened, wherein expiration of said product is influenced by the opening of said package, and means for determining an expiration date of said product for the open package. In this case a tag or a package transmits the change of the opening status to a reader. Subsequently the reader determines an expiration date for the product. Therefore additional data such as the type of product, e.g. “milk”, “cheese”, or “sausage” can be transmitted to the reader to allow a better determination of an expiration date.

It is further advantageous when the reading device comprises monitoring means to monitor at least one parameter affecting expiration of said product, and means for adjusting said expiration date according to monitored parameter(s). In this way it is possible that a single reader monitors storage parameters such as the temperature for a couple of packages that do not need such a sensor. An example would be a reader in a refrigerator whose internal space has nearly the same temperature.

Finally it is also advantageous when said monitoring means are remote from the device, and wherein the reading device comprises a receiver for receiving data therefrom. Monitoring of storage conditions in this case happens within a tag or a package. Hence each package transmits for example a value for the measured pressure (which can not determined outside of a package) to the reader, which again adjusts the expiration date based on that information.

These and other aspects of the present invention will be apparent from, and elucidated with reference to, the embodiments described herein.

### BRIEF DESCRIPTION OF THE DRAWINGS

Embodiments of the present invention will now be described by way of examples only and with reference to the accompanying drawings, in which:

FIG. 1 is a graphical illustration of acceptable storage conditions for certain types of perishable foodstuffs;

FIG. 2a is a schematic side view illustrating a package according to an exemplary embodiment of the present invention;

FIG. 2b is a bottom view of the package of FIG. 2a;

FIG. 3a shows a mechanical switch (closed) associated with a pop-up button;

FIG. 3b shows the switch of FIG. 3a in its open position;

FIG. 4 shows a rip strip attached to a package;

FIG. 5a shows a simple inventive tag with an external opening detector;

FIG. 5b shows an inventive tag with on-board temperature and pressure sensor;

FIG. 5c shows a tag according to FIG. 5b wherein timer is integrated into the processor;

FIG. 5d shows a tag according to FIG. 5b wherein timer is integrated into the memory;

FIG. 6a shows a table with factors reducing an expiration date dependent on the temperature of a product;

FIG. 6b shows a table similar to FIG. 6a but with factors extending an expiration date dependent on the temperature of a product;

FIG. 6c shows a table according to FIG. 6b wherein additionally time periods for temperature measurements are stored.

FIG. 7 shows the graph of a function to determine a factor reducing an expiration date

FIG. 8 is a flow diagram illustrating a method according to an exemplary embodiment of the present invention.

### DESCRIPTION OF EMBODIMENTS

As stated before, it has been established that calculation and monitoring of expiration or “use by” dates of perishable items is not necessarily trivial, and the present invention provides a solution to some of the problems associated with this process. In the following specific description, the perishable items referred to will comprise foodstuffs. However, it will be appreciated that the embodiments described herein are equally applicable to other types of perishable items, including medical supplies generally, pharmaceuticals, biological samples, etc. packed in tins, boxes, pouches, jars, bottles and the like.

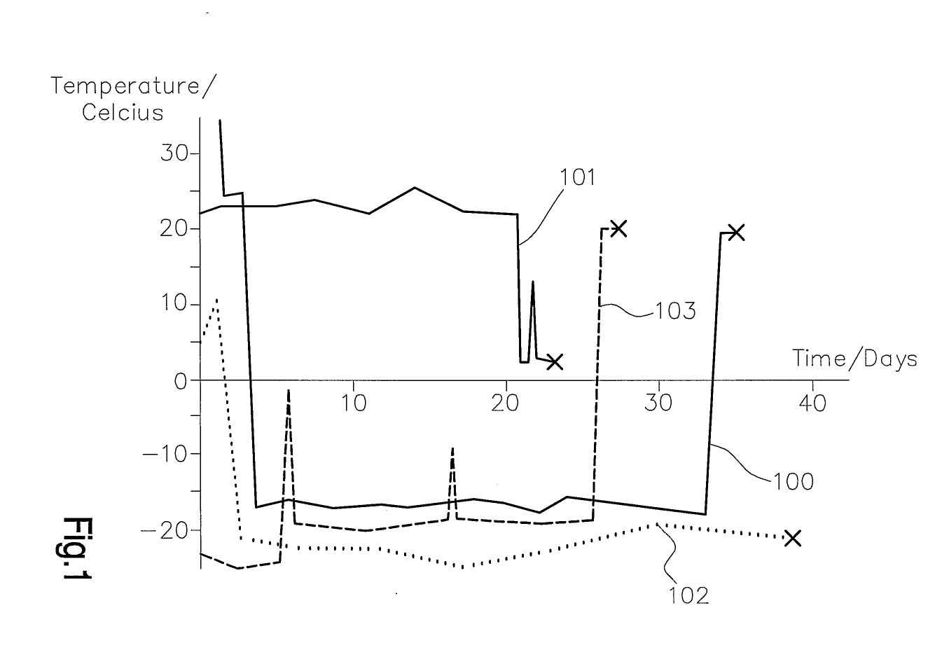

FIG. 1 illustrates graphically some exemplary storage conditions applied in respect of a number of different products. Referring to trace 100, a loaf of bread in plastic wrapping or the like may last several days when stored at room temperature. However, its life can be considerably extended by freezing it within one day of baking. It may then be stored at freezer temperature for up to one month. However, upon defrosting, it must be consumed within 24 hours, after which time any remaining bread in the loaf should be discarded, as indicated by X on the graph of FIG. 1.

On the other hand, and referring to trace 101, a jar of pasta sauce may be stored at room temperature for up to, say, a year, and this shelf life tends to be printed on the jar. Once opened, however, the contents are required to be refrigerated and consumed within, say, three days of opening. Periods of time for which the product is kept out of the refrigerator should be kept to a minimum, otherwise the product is likely to spoil even earlier. Provided these guidelines are followed, three days after the jar has been opened, any remaining product should be discarded.

Referring to trace 102, a vacuum packed, chilled meal should usually be eaten by a “use by” date, which tends to be printed on the packaging, provided the product is kept refrigerated. However, it is often possible to freeze the product, provided this is done as soon as possible on the day of purchase, which can then extend the life of the product by, say, a month. Although this is not illustrated in the graph of FIG. 1, if the meal has been frozen, it is important to ensure that the product is defrosted thoroughly before it is eaten.

Finally, trace 103 illustrates the case of a tub of ice cream, removed from a commercial cold storage unit and transported to a purchaser's home where it is stored for some time in a domestic freezer appliance. Any period of time the product is kept out of the freezer appliance should be as short as possible, and in the illustrated case, the tub of ice cream has been allowed to defrost such that it should be discarded because it is not permitted to re-freeze the product once it has defrosted.

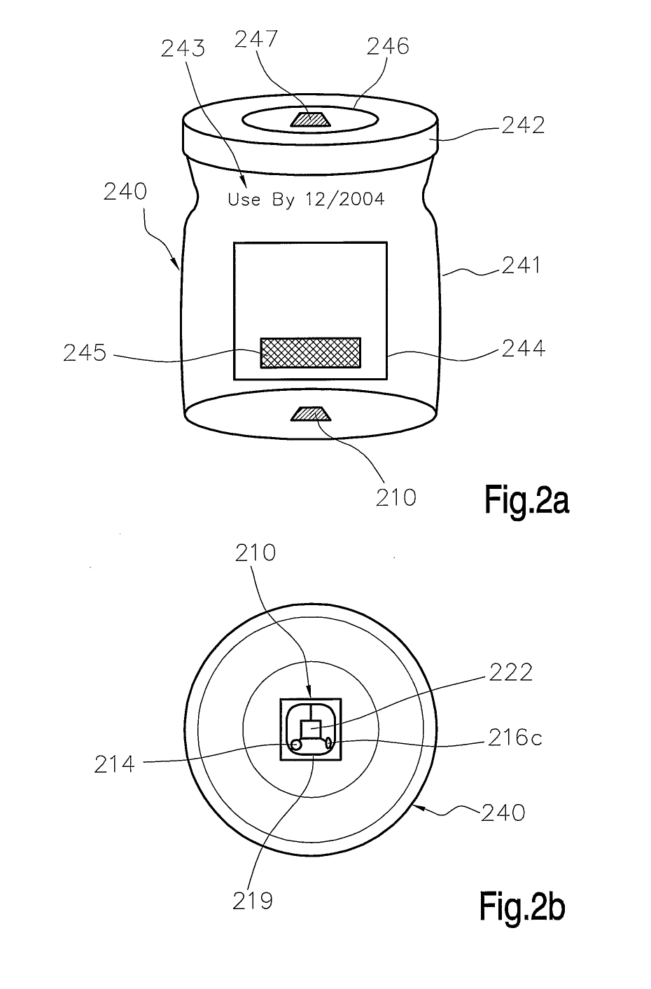

Referring now to FIG. 2a of the drawings, a package 240 according to an exemplary embodiment of the present invention, comprises a jar 241 having a screw-top lid 242 within which a perishable product (not shown) may be contained, having been introduced into the jar 241 in a protective atmosphere. Thus, the product has a relatively long shelf life whilst the jar 241 remains tightly closed. This shelf life is generally identified by a conventional “use by” date 243 provided on the neck of the jar 241. The label 244 on the side wall of the jar 241 further provides an indication 245 of the storage conditions that will apply once the jar 241 has been opened, e.g. “See neck for use by date. Once opened keep refrigerated and use within three days of opening”.

The lid 242 of the jar 241 is provided with a conventional “pop up” button 246, which enables a user to detect whether or not the jar 241 has been opened or tampered with. An inventive tag 210 is provided at the base of the jar 241 and is preferably secured thereto. It is beneficial in this case for the (RFID) tag 210 to be located as far away from the (metal) lid 242 as possible, so as to minimise the likelihood of the metal lid 242 interfering with the RF signal. In one embodiment, a special label 247 may be provided, say on the lid 242 of the jar 241 in association with the pop-up button 246, to indicate to a potential consumer of the presence of the tag 210, thereby identifying to the consumer that that particular jar 241 is capable of providing a service that provides an advantage over other comparable jars of the same product. In any event, it may be desirable to inform the consumer of the presence of the tag 210 and its functionality, so as to assuage any privacy concerns they may otherwise have over the purpose of the tag 210.

Referring to FIG. 2b of the drawings, the structure of the tag 210 can be seen in more detail from the underside of the jar 241. The tag 210 comprises a control circuit 222 which drives a loop antenna 219, accepts signals from a pressure sensor 216c, and is capable of tracking the time elapsed since the package 240 was first opened through a timer 214.

In more detail, the tag 210 includes a pressure sensor 216c that detects the moment at which the package 240 is first opened. Opening detection may be accomplished by said pressure sensor 216c, as illustrated in the arrangement of FIG. 2b, or a rip strip 216b or a mechanical switch 216a, 216a′ associated with the conventional pop-up button 246. In fact, many different ways of determining when the package 240 is first opened will be apparent to a person skilled in the art, and the present invention is not necessarily intended to be limited in this regard. A temperature sensor 215, such as a thermometer, may be used to sense the temperature of the product and/or the packaging surroundings affecting the safe storage time to be monitored, periodically or otherwise.

The antenna 219 is required to send an RF signal to a remote reader device (not shown). In the illustrated example, the antenna 219 is shown to be a loop antenna similar to that used in known RFID tags. Means are provided for measuring time elapsed since the package 240 was first opened, although in most cases the passage of time need not be measured particularly accurately for the purposes of the present invention. For example, typically the maximum length of time for which a product provided in a tin or jar 241 may need to be monitored will only be a few days, in which case a discrepancy of an hour or so over these few days would be acceptable. On the other hand, in the case of a product that could be legitimately stored in a domestic freezer for several months, a discrepancy of a few days over the whole period would be acceptable.

The tag 210 is further provided with a power source 218 (not shown) for running at least the timer 214. If the device is to act as an active tag 210, the power source 218 must also be capable of driving the RF circuit in order to send at least a brief signal to a reader 220 (not shown). This envisages the tag 210 sending occasional reports indicating an expiration status of the product and (optionally) a time left before the product must be consumed or discarded. For example, for most applications, a signal once a day would be adequate. Alternatively, however, a signal may only be transmitted when an expiration status of the product changes or is about to change.

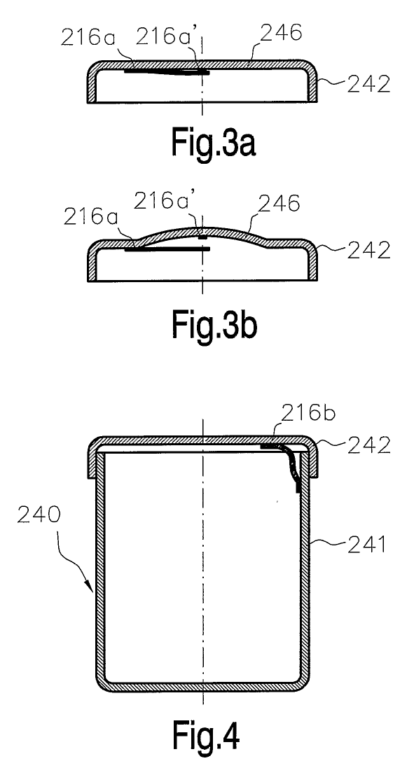

FIG. 3a shows an example of an opening detector for a lid 242 with a pop-up button 246 wherein the jar 241 is omitted for reasons of brevity. It is assumed that product was filled into package 240 under vacuum so that the pop-up button 246 is in its lower position shown in FIG. 3a. A first switching contact 216a and a second switching contact 216a′ being currently in contact form a (closed) opening detector switch. If the package 240 is then opened, pop-up button 246 moves to its upper position thus opening the switch 216a, 216a′ (shown in FIG. 3b). If contacts 216a, 216a′ are fed to processor 212 forming a current loop they could serve as an opening detector in this way.

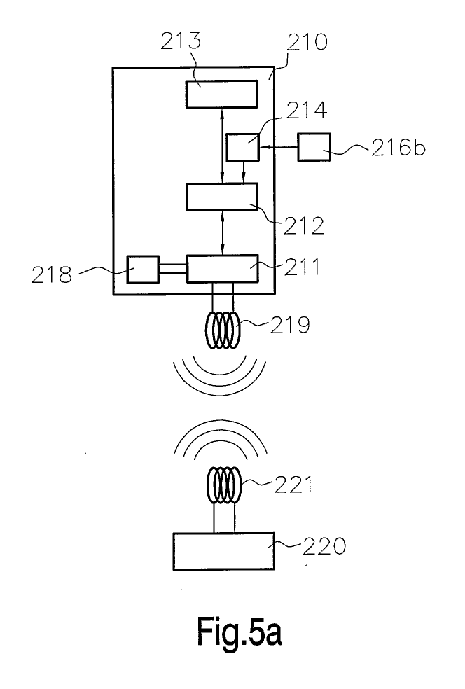

FIG. 4 shows a further possibility for an opening detector in form of a rip strip 216b. When lid 242 is put onto jar 241 after the product was filled into said jar 241 rip strip 216b is connected to lid 242 as well as to jar 241 thus forming a seal. If package 240 is opened the rip strip 216b is broken. If the rip strip 216b is part of a current loop it can again serve as an opening detector.

It should be noted that there are a couple of possibilities to realize an opening detector. Therefore switch 216a, 216a′ and rip strip 216b can only serve as exemplary embodiments of such mechanical opening detectors.

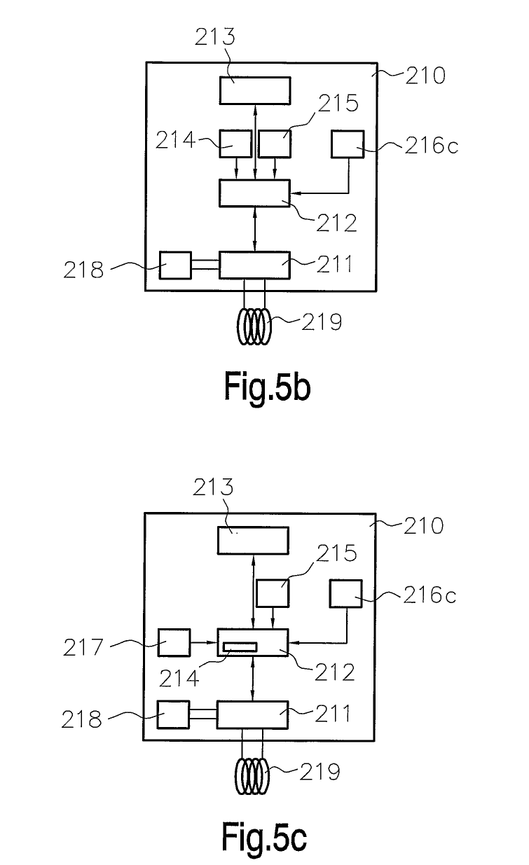

Referring now to FIG. 5a of the drawings, an electronic tag 210 for use in accordance with an exemplary embodiment of the present invention is shown on which is provided a radio interface 211 connected to a tag antenna 219, a processor 212, a timer 214 a memory 213 and a power source 218. The processor 212 is connected to the radio interface 211 as well as to the memory 213. Furthermore timer 214 is connected to the processor 212. Finally power source 218 is connected to the radio interface 211.

FIG. 5a additionally shows a so-called reader 220 with a reader antenna 221 which reader 220 is to communicate with the tag 210 via symbolically shown radio waves. Also shown is a rip strip 216b, which is not on the tag 210 itself but connected to it.

The function of the arrangement shown in FIG. 5a is as follows. When the perishable product is manufactured, an expiration date is written into memory 213 by means of a reader 220. In this example only an expiration date for an open package 240 is stored because it is assumed that the product does not spoil very fast when the package 240 is closed but spoils very fast when package 240 is open. An example are sardines in a tin which can be stored over years even if they are not cooled but should be consumed within a day if the tin is open.

When the reader 220 emits the radio field via the reader coil 221 the field is received by the tag coil 219 and transmitted to the radio interface 211. Not only is the data transmitted to processor 212 extracted out of the radio field but also power is extracted which is visualized by the power source 218. Preferably the power source 218 comprises storing means such as an accumulator or a capacitor so that tag 210 can also work independently of a radio field. It is needless to say that also additional data besides the expiration date can be stored on the tag 210, such as a unique identification number, ingredients of the product, price, manufacturer, etc. After this writing procedure the package 240 comes to the consumer in a well known way who now opens the package 240.

A timer 214 is triggered by a signal coming from the rip strip 216b indicating that the product packaging 240, in respect of which the tag 210 is supplied, has been opened. It is assumed that timer 214 counts upwards starting from zero. To change the status from “eatable” to “spoiled” processor 212 regularly compares the value of the timer 214 with the expiration date stored in memory 213, which expiration date is the time span from opening the package 240 until the product is believed to be spoiled in this case. Therefore the independent power source 218 is needed.

When the package 240 is stored nearby a reader 220 which may be part of a refrigerator the reader 220 can interrogate the tag 210. If so, processor 212 can compute the time span until the product is spoiled and transmit this value to the reader 220 which can alert a user if the product is expired or about to expire.

FIG. 5b shows another embodiment of the invention where in comparison to the embodiment according FIG. 5a an electronic tag 210 additionally comprises a temperature sensor 215 and a pressure sensor 216c which are both connected to the processor 212. In contrast to FIG. 5a, timer 214 is not triggered by a signal line from an external opening detector. Finally reader 220 is omitted for reasons of brevity.

Tag 210 is now mounted within package 240. The perishable product is packaged under vacuum respectively reduced pressure so that later opening of package 240 results in a significant rise of the pressure within the package 240. This fast rise is measured by the pressure sensor 216c and reported to the processor 212 where it is interpreted as an opening of package 240 (this interpretation can also be done within pressure sensor 216c).

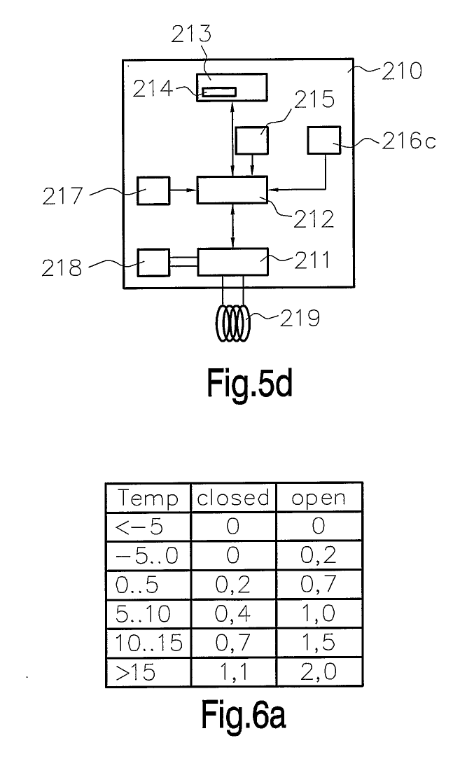

It is assumed that a table according to FIG. 6a and an expiration date for example “Jan. 30, 2005” has been stored in the memory 213 when the perishable product was manufactured. The table shows reduction factors, which depend on the storing temperature as well as on the opening status of the package 240. The expiration date is calculated for ideal conditions in particular when the product is frozen. So if the package 240 is stored below −5 degrees Celsius the expiration date is not reduced. But if the package 240 is stored for example at 7 degrees Celsius the expiration date is reduced according to the following formula:
Date_{new}=Date_{old}−Δtime·K_{red}

where Δtime is the time span between two temperature measurements, K_{red} is the factor according to the table, Date_{old} is the old expiration date and Date_{new} is the new expiration date. So if for example temperature is measured every eight hours and a temperature of 7 degrees is measured the expiration date is reduced by 0.4·8 h=3.2 h for the closed package for each measurement. If the package 240 is constantly stored for 30 days the expiration date is reduced to “Jan. 18, 2005”. The user now opens the package 240 and leaves it out of the refrigerator so that the temperature rises to 21 degrees Celsius and so that expiration date is reduced by 16 h every 8 h because reduction factor 2.0 is chosen from now on. So if the user leaves the package 240 out of the refrigerator for further 5 days expiration date is changed to “Jan. 8, 2005”.

Tag 210 can be arranged to determine a status of the product. So the status can change from “excellent” to “good” and “eatable” to “nearly spoiled” and “spoiled”. This could be useful for product for which the quality is highly dependent on the storage time and storage condition such as cheese. A piece of Camembert is excellent for a certain time period; afterwards it is eatable but not as good as before. In this case the status can also change from “good” to “excellent” and back to “good” again if the cheese has to ripen for a certain time period to reach it's highest quality.

Tag 210 can also be arranged to alert a user for instance 2 days before a product is definitely spoiled so that he has the opportunity to consume it. This time span can be fixed or variable. In the second case processor 212 can be arranged to take into consideration the storing conditions and predict a certain time to handle. This is useful for example if a product preferably is consumed with a certain status. So coming back to the Camembert processor 212 can be arranged to alert a user when a product has its highest quality, which lasts a certain time span depending on the storage condition. An output of the tag 210, which usually is performed by help of a reader 220, can be: “Please consume product ‘Camembert’ within the next 2 days for highest enjoyment”. Since this time span varies it can be 10 days if the product is kept cold.

It is further possible that an expiration date is calculated for worst conditions, e.g. storing a product at room temperature, and extended when it is stored under better conditions. An according table could therefore be similar to that one shown in FIG. 6b, which contains an extension factor Kₑₓₜ. The formula to adapt an expiration date would be:
Date_{new}=Date_{old}+Δtime·Kₑₓₜ

If the time span between two temperature measurements is fixed it is also possible to store an absolute time value within the table instead of a factor. A factor in particular is useful if said time span is reduced if temperature rises so that the expiration date can be calculated correct even under critical conditions. So for example a measurement can take place each day when a product is frozen and four times a day if a product is stored above 15 degrees Celsius. It is further imaginable that a period for measurements is stored in memory 213 when the product is manufactured. An example for such a table is shown in FIG. 6c, where an additional column “time” shows when the next temperature measurement has to take place depending on the storage temperature. Furthermore table does not show an extension or reduction factor but an absolute time value. All values in the table are furthermore shown in days so that a new expiration date can be calculated by the processor 212 more easily (simply with additions or subtractions). That means with less operations, which further means with less energy, which could be important with respect of the limited energy stored in power source 218. The values of table 6c are derived from those from table 6b. In particular, there could also be a column “re-closed” if the product spoils more slowly when the package is resealed.

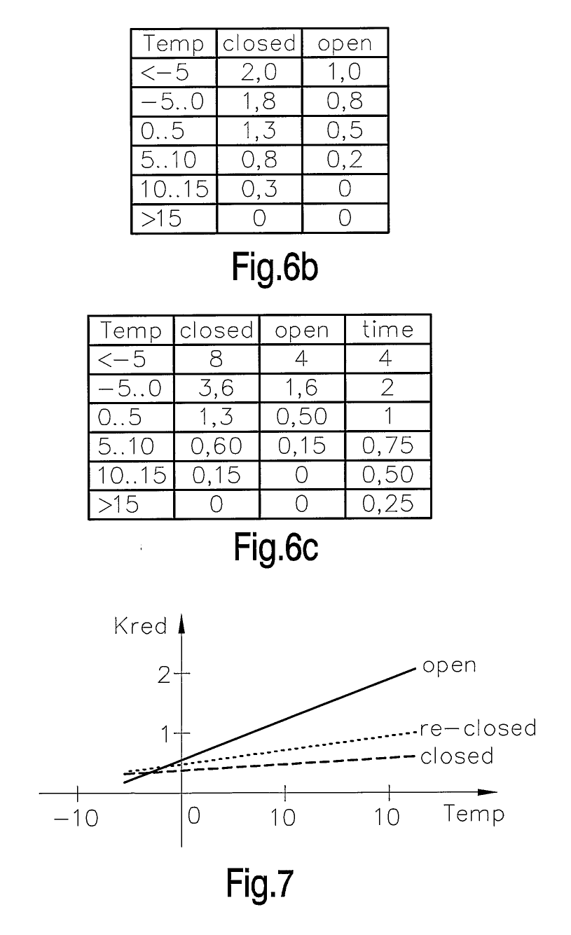

It is further possible to use a function that reduces or extends an expiration date, rather than a table as shown in FIGS. 6a.6c. An easy way to do so is to use linear equations as shown in FIG. 7:
Date_{new}=Date_{old}−Δtime·(0.5+0.7·Temp·[1/10° C.]) (package open)
Date_{new}=Date_{old}−Δtime·(0.3+0.1·Temp·[1/10° C.]) (package closed)
Date_{new}=Date_{old}−Δtime·(0.4+0.3·Temp·[1/10° C.]) (package re-closed)
The initial expiration date is valid for a temperature where the corresponding graph crosses the abscissa of the diagram. In our case this is −30 degrees Celsius for the closed package and −7 degrees Celsius for the open package. If the initial expiration date is determined for 0 degrees, the constant in the equation can preferably be dropped.

The graph in FIG. 7 also shows the possibility to take into consideration open packages 210 which are closed again. Usually a product spoils faster when a package 210 is kept open in comparison when it is closed again. This fact is used to adjust the expiration date of the product more accurately. Hence a special opening detector is needed which is able to detect both opening and closing a package 210. Conductive layers on top of a jar 241 and on the lower side of the lid 242, which form a current loop, can serve for this purpose.

It is easy to understand that the proposed method also works for extending of expiration dates. An example (not shown in figures) would be:
Date_{new}=Date_{old}+Δtime·(2−0.7·Temp·[1/10° C.]) (package closed)
Date_{new}=Date_{old}+Δtime·(0.8−0.4·Temp·[1/10° C.]) (package re-closed)
Date_{new}=Date_{old}+Δtime·(0.6−0.3·Temp·[1/10° C.]) (package open)
It is further easy to understand that a great variety of functions can be used for adjusting expiration dates. A few examples are polynomial functions, logarithmic functions, exponential functions, etc.

It is also imaginable that pressure sensor 216c is not only used for detecting the opening of package 240 but also for determining an expiration date. It might be possible that the expiration of a product also depends on the pressure within the package 240. So there might be a second table that contains reduction or extension factors depending on pressure. In this case the expiration date for leaky packages 240 can also be determined. The leakage can be considered a “slow” opening for the purposes of the invention.

In general it should be noted that temperature sensor 215 and pressure sensor 216c have an exemplary meaning in the light of detection of spoiled products. The skilled in the art can easily imagine that there are a great variety of sensors which are applicable for such a purpose and which work well together with the proposed method of monitoring. One example is a sensor that is arranged to determine the chemical structure of the atmosphere within a package 240. It is easy to understand that a product spoils much faster if there is high percentage of oxygen in it.

FIG. 5c now shows yet another embodiment of the invention. In comparison to FIG. 5a the timer 214 is integrated into the processor 212. For example this could be a special register in processor 212. Such timer 214 is quite common for standard processors 212, since monitoring of time is often needed in standard applications. The absolute value of time is derived from the additional clock generator 217 whose output is fed into processor 212. The function of such an integrated timer is clear for one skilled in the art and is therefore not further explained.

FIG. 5d finally shows a further variant for the inventive tag 210 wherein the register of FIG. 5c is omitted and a certain address in memory 213 is used instead. So the timer 214 is integrated in memory 213. Each time its value has to be changed, it is fetched from said address, changed and written back again. This technique is also well known and does not need further explanation.

In conclusion, the features of the invention are summarized again. Predetermined storage “rules” may be stored within the processor 212, which may then be arranged to compare the actual storage conditions, indicated by the temperature measurements, with the storage rules.

Provision of the tag 210 in or on a perishable product enables the product's storage conditions to be compared with a predefined set of conditions for that particular product, and infringements to be reported, either as they occur or just as they are about to occur, so as to act as a warning that some action in respect of the product is required, either immediately or soon. Alternatively, however, the tag 210 could be used in a passive mode, in which case the status of the product is not reported until the tag 210 is actually interrogated by a reader. In either case, the reader may be arranged to generate an alarm or warning signal to a user, indicating that action is, or will soon be, required in respect of a product for which the expiration date has been, or will soon be, reached.

In general, it is not necessary in many exemplary embodiments of the present invention for the tag 210 to be re-triggered by a signal from a opening sensor 216a, 216a′, 216b, 216c indicating opening of the package 240 every time the product is used. In such cases, it is more efficient to simply start the timer 214 in response to the package 240 being first opened, and the timer then automatically keeps track of the time elapsed since first opening. If, as in the exemplary embodiments illustrated in FIGS. 5b.5d of the drawings, a temperature sensor 215 is fitted, this may be arranged to supply readings periodically to the processor 212 for assessment thereby of the storage conditions applied to the product in question by comparing the temperature readings against the above-mentioned storage rules for that particular product. It will be appreciated that, for many products (such as those packaged in airtight tins and jars) it may not be necessary to start taking temperature readings until the packaging has been opened for the first time, as indicated by a signal from an opening detector 216a, 216a′, 216b, 216c.

Thus, in the example described above, the tag 210 itself performs, after first opening of the package 240, the assessment of the time and temperature conditions in relation to the product to which it is attached. In an alternative exemplary embodiment, however, the reader 220 may be arranged and configured to receive data indicative of the time and/or temperature conditions in relation to all products with which it is associated, and to perform the requisite comparison and monitoring functions. On the other hand, there are several advantages in having the tag 210 itself perform the assessment of the time and/or temperature conditions, rather than relying on the reader 220 to keep track of the time schedule for all products with which it is associated. For example, if the reader 220 were arranged to monitor the expiration schedule for all of the products in a refrigerator, alarm signals might be generated for products which have already been consumed or discarded (and the user may be required to disable the alarm function for each product as it is discarded), whereas if each tag 210 is performing the monitoring function in respect of the product with which it is associated, then when the package 240 is discarded, the tag 210 is discarded along with the package 240, thereby removing it from within the operating range of the reader 220 and preventing any (further) alarm signals being generated in respect of the discarded product.

Of course, in the case where the perishable products in question are pharmaceutical products, the reader 220 may be arranged and configured to monitor the quantity of the product remaining in the package 240 by, for example, monitoring each opening of the package 240 and calculating (by means of the dosage) how much of the product is taken each time, and therefore how much is left. In fact, it may also be arranged to actively keep track of product usage to ensure that no dose of medicine is missed or to provide a warning if too much is taken. In any event, where the quantity of product remaining is being monitored in respect of a set of packages 240, then it is conceivable that the reader 220 may then be arranged to monitor the time schedule for all of those products, because it could be arranged to “presume” that a package 240 has been discarded once it is perceived to be empty, thereby triggering automatic disablement of the respective alarm signal. This is not particularly practical in the case of foodstuffs, such as jars 241 of pasta sauce, because the reader 220 would have no way of knowing how much (if any) of the product is dispensed every time its package 240 is opened.

In the case of foods and medicines that need to be kept refrigerated, for example, a tag according to an exemplary embodiment of the present invention may be arranged and configured to generate an alarm or warning signal if it determines that such a product has been left out of the refrigerator (for example, in response to consecutive elevated temperature readings being received for more than some predetermined period of time, the timing of which may be triggered in response to receipt of a first elevated temperature reading).

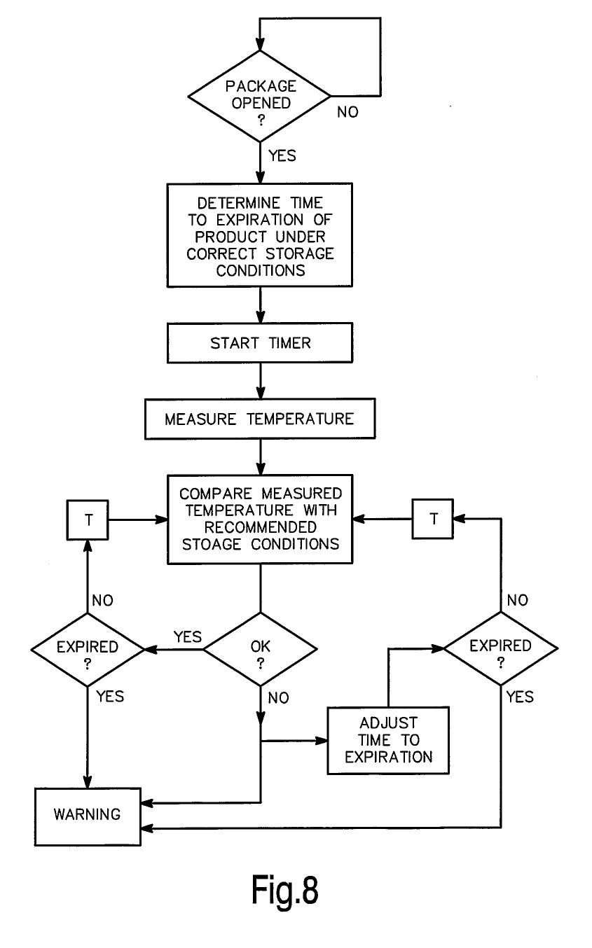

Referring now to FIG. 8 of the drawings, a method according to an exemplary embodiment of the present invention for monitoring an expiration status of a perishable product contained within a package 240, will now be described. No action is taken until it is determined that the package 240 has been opened for the first time. In response to this event, a processor 212 in the tag 210 or in a remote location (e.g. in a reader 220) determines the time to expiration of the product under the correct (recommended) storage conditions and then starts the timer 214. In addition, the temperature sensor 215 is caused to start monitoring the temperature of the product and/or the surroundings in which the package 240 is located. The measured temperature is compared with the temperature(s) stored in respect of the recommended storage conditions. If the measured temperature is within acceptable storage conditions, and the product is not considered to have expired, the temperature measurement and comparison process is repeated after a predetermined period of time T. On the other hand, if the measured temperature falls outside the acceptable storage conditions, the time to expiration is adjusted to allow for the incorrect storage conditions and a warning signal may be generated. Then, if the product has not expired, then the temperature measurement and comparison process is repeated after a predetermined period of time T. In any event, once the product is considered to have expired, or is about to expire (in accordance with the determined time to expiration and the status of the timer), a warning signal is generated.

Of course, it is also possible for the tag 210 to be used in an entirely passive mode, where the tag 210 only reports its status when prompted to do so by a reader 220. In this case, the power source 218 needs only to be able to run the timer 214 and temperature sensor 215 (where provided). In any event, little power is required and a capacitive method of power storage is likely to be adequate, if supplied periodically by the action of the reader 220. It is also possible that timing means are incorporated in the reader 220, which interrogates tag 210 to measure the temperature or the pressure or to transmit the opening status of package 240. In this case tag 210 can be fully passive meaning that power source 218 does not need to store energy since the energy for measurement comes from the radio field of the reader 220. It should be noted that this embodiment only works well in closed systems. If package 240 travels around such as it is for products in real life the preferred solution would be monitoring within the package 240.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A method of positioning and fixing at least one element relative to or on a frame, in particular a display, having a mount, of a projection device on a frame for another optically active element of the projection device that is arranged on the frame, wherein the element or the mount of the display and mount parts of the frame are formed on plastic sections that are to be connected to one another, said method comprising:
positioning the element, in particular the display, relative to the frame;
adjusting the element relative to the frame;
connecting the element to the frame, by using laser plastic welding, in particular point laser plastic welding.

2. The method of claim 1, wherein the adjustment of the element relative to the frame is carried out with the interconnection of in particular elastically movable intermediate elements which jut out at least partially from the mutually facing edge or boundary surfaces of the element and/or frame.

3. The method of claim 2, wherein the connection by laser plastic welding between the element and the frame is carried out in the region of the intermediate elements which jut out.

4. The method of claim 1, wherein the element or the mount of the display is formed, at least in the region where it is connected to the frame, of a transparent plastic or a plastic of lower absorption than the absorption capability of the plastic of the frame.

5. A projection device for projecting image information, comprising at least one display which is to be positioned relative to a frame of another optically active element of the projection device and fixed to said frame, wherein at least one mount of the display and the frame are formed of plastic at regions that are to be connected to one another, wherein the mount of the display is fixed to the frame in its position relative to the frame by weld spots or a weld seam which are/is produced by laser plastic welding.

6. The projection device of claim 5, wherein in particular elastically movable intermediate elements which jut out are provided on mutually facing surfaces of the mount of the display and/or the frame, on which intermediate elements the weld spots and/or weld seam are/is made in order to fix the display on the frame.

7. The projection device of claim 6, wherein the intermediate elements are formed by leaf-spring-like plastic elements which are clamped at one side and jut out, which plastic elements extend essentially parallel to the edge of the boundary surface of the mount and the frame and in each case are fixed to the mount of the display or the frame at a corner region.

8. The projection device of claim 6, wherein the intermediate elements are oriented by their free ends in opposite directions on essentially parallel boundary surfaces of the frame, which frame has an essentially rectangular or square outer contour.

9. The projection device of claim 5, wherein the mount of the display is designed, in regions where it is fixed to the frame by laser plastic welding, with a cross section that is smaller than the cross section of adjoining part-regions of the mount.

10. The projection device of claim 5, wherein the mount of the display is made, at least in the region where it is connected to the frame, of a transparent plastic or a plastic of lower absorption than the absorption capability of the plastic of the frame or intermediate elements.
